(19) United States
(12) Patent Application Publication
(10) Pub. No.: US 2010/0096922 A1
(43) Pub. Date: Apr. 22, 2010

(54) Power Supply System, Power Supply-Side Control Unit, And Electric Vehicle Incorporating Said System

(75) Inventor: Keiji KISHIMOTO, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/603,210

(22) Filed: Oct. 21, 2009

(30) Foreign Application Priority Data
Oct. 22, 2008 (JP) 2008272395

(51) Int. Cl. B60L 1/00; H02J 1/10

(52) U.S. Cl. 307/9.1; 307/80

(57) ABSTRACT

A power supply system and a power supply-side control unit and an electric vehicle are described. The power supply device comprises a plurality of power storage devices connected in parallel. When the temperature of any power storage device is higher than the predetermined temperature TH, the power supply-side control unit 211 performs the duty ratio control for the power storage devices. Also, the power supply-side control unit 211 transmits a temperature control notification signal indicative of the current temperature control condition to a load-side control unit 221, which in turn controls the electric power that is consumed or generated by the load 220 on the basis of the temperature control notification signal. The life of the power supply device as a whole is therefore prevented from shortening by inhibiting the temperature rise and temperature variation in each power storage device. It is also possible to prevent the power supply system from halting due to occurrence of an error.

### CROSS REFERENCE TO RELATED APPLICATIONS

This application claims priority based on 35 USC 119 from prior Japanese Patent Application No. P2008-272395 filed on Oct. 22, 2008, the entire contents of which are incorporated herein by reference.

### BACKGROUND OF THE INVENTION

1. Field of the Invention

The present invention relates to a power supply system including a power supply device, a power supply-side control unit, and an electric vehicle that incorporates such power supply system.

2. Description of Related Art

To achieve high capacity and high power, a power supply system that includes a power supply device having a plurality of power storage devices connected in parallel is generally known. Such power supply system for example is used in an electric vehicle.

For each such power storage device, a current allowed to flow through the power storage device (hereinafter referred to as an “allowable current”) is established. If the current that flows through the power storage device exceeds the allowable current due to for example variation or change in the internal resistance of each power storage device, deterioration of the power storage device becomes accelerated.

Thus, technology was proposed in which a current that flows through each power storage device is controlled such that the current that flows through each power storage device does not exceed the allowable current. See e.g. Japanese Patent Laid-Open No. 2008-118790.

More precisely, the power supply device has a current distribution unit connected in series to the power storage device. The current distribution unit controls the current that flows through the power storage device by changing a resistance value of a resistance provided in the current distribution unit.

As described above, deterioration of the power storage device is accelerated when the current that flows through it exceeds the established allowable current due to for example variation or change in the internal resistance of the power storage device.

In addition, if the temperature of each power storage device varies largely due to its positional relationship and a difference in the heat release property of each power storage device, the degree of deterioration varies among the power storage devices. Since the life duration of the entire power supply device is determined by the life duration of the most deteriorated power storage device, if the degree of deterioration in each power storage device varies, the life duration of the power supply device is reduced.

In the above-described technology, while the current that flows through each power storage device is controlled such that it does not exceed the allowable current, variation in the temperature of each power storage device was not considered. In other words, in the above-described technology, shortening of the life duration of the power supply device is still caused by the temperature variation in each power storage device, even though allowable current flow is controlled.

Moreover, when a control is performed such that the current that flows through each power storage device does not exceed the allowable current and when the peak power output of each power storage device is reduced in order to reduce variation of temperatures of each power storage device, the power supply device cannot generate a rated output power. In other words, the electric power that can be output by the power supply device becomes smaller than the rated output power. In such a case, if an output request of an electric power is made which exceeds the electric power that can be output, there is a possibility that the power supply system may halt by considering that an error has occurred within the power supply system.

Similarly, when a control is performed such that the current that flows through each power storage device does not exceed the allowable current and when the peak power output of each power storage device is reduced in order to reduce variation of temperatures of each power storage device, the power supply device cannot be charged with the rated input power. In other words, the electric power that can be input in the power supply device becomes smaller than the rated input power. In such a case, if an input request of an electric power is made which exceeds the electric power that can be input, there is a possibility that the power supply system may halt by considering that an error has occurred within the power supply system.

Therefore, an object of the invention is to solve the above-described issues and to provide a power supply system, power supply control unit, and an electric vehicle which can reduce shortening of the life duration of the device as a whole by restraining the increased temperature and the varied temperature of each power storage device, and which can restrain system halt of the power supply system due to an occurrence of an error.

### SUMMARY OF THE INVENTION

One aspect of the invention relates to a power supply system including a power supply device having a plurality of power storage devices connected in parallel; a plurality of temperature detection units for respectively detecting temperatures of the plurality of power storage devices; and a plurality of switch elements respectively connected in series with the plurality of power storage devices, and load electrically connected to the power supply device, in which the power supply system further includes a power supply-side control unit for controlling the ON and OFF states of the switch elements and a load-side control unit for controlling an electric power consumed at the load or an electric power generated by the load, in which the power supply-side control unit performs a temperature control of the plurality of power storage devices respectively by controlling a time ratio of the ON and OFF states in controlling the ratio of ON and OFF states of the switch elements based on the temperatures detected by the temperature detection units, in which the power supply-side control unit sends a notification indicating a performing status of the temperature control to the load-side control unit, and in which the load-side control unit controls the electric power consumed at the load or the electric power generated by the load based on the notification received from the power supply-side control unit.

One embodiment of the present invention provides a power supply system comprising: a power supply device comprising a plurality of power storage devices connected in parallel, a temperature detection unit operable to detect the temperatures of the power storage devices, and a plurality of switch elements connected in series to the power storage devices respectively; a load electrically connected to the power supply device; a power supply-side control unit operable to control the on-state and off-state of the switch elements; a load-side control unit operable to control the electric power that is consumed or generated by the load, wherein the power supply-side control unit performs a temperature control for the plurality of power storage devices by controlling the time ratio between the on-state and off-state of each switch element on the basis of the temperature detected by the temperature detection unit, wherein the power supply-side control unit transmits a notification signal indicative of the execution condition of the temperature control to the load-side control unit, and wherein the load-side control unit controls the electric power that is consumed or generated by the load on the basis of the notification signal received from the power supply-side control unit.

The power supply-side control unit can perform the temperature control by the following method (1) or (2).

(1) The switch elements are turned on or off on the basis of the temperatures detected by the temperature detection unit. Specifically, when the temperatures detected by the temperature detection unit is higher than a predetermined temperature, the switch elements are turned off.

(2) A PWM signal is output to each switch element on the basis of the temperatures detected by the temperature detection unit such that the switch element is turned on or off corresponding to the high or low state of the PWM signal. Specifically, when the temperatures detected by the temperature detection unit is higher than a predetermined temperature, the time ratio of the on-state is decreased during controlling the on/off state of the switch element with the PWM signal.

Preferably, in the invention as described above, the notification signal contains information about the maximum input-output electric power value which can be input to or output from the power supply device, and wherein the load-side control unit controls the electric power that is consumed or generated by the load to remain within the range that does not exceed the maximum input-output electric power value.

Incidentally, the maximum input-output electric power value may be represented by a maximum power value (W), the ratio of this maximum power value (W) to the rated input-output electric power value (W) of the power supply device, a maximum current value (A), the ratio of this maximum current value (A) to the current value (A) corresponding to the rated input-output electric power value, or the like.

Preferably, in the invention as described above, the load-side control unit notifies the user of the execution condition of the temperature control through the notification signal.

Preferably, in the invention as described above, the power supply device comprises: a voltage detection unit operable to detect the voltage of each of the power storage devices; a current detection unit operable to detect the current of each of the power storage devices; and a remaining charge computation unit operable to compute the remaining amount of charge (SOC: State Of Charge) in each of the power storage devices, wherein the power supply-side control unit transmits the notification signal together with information about the remaining amounts of charge in the power storage devices computed by the remaining charge computation unit, wherein, on the basis of the remaining amounts of charge in the power storage devices and the electric power that is consumed or generated by the load, the load-side control unit computes command values of the time ratios between the on-state and off-state of each switch element for controlling the on-state and off-state thereof, followed by transmitting the command values to the power supply-side control unit, and wherein, in a period in which the temperature control is not performed, the power supply-side control unit controls the switch elements between the on-state and off-state thereof on the basis of the command values received from the load-side control unit.

Preferably, in the invention as described above, at least one of the power storage devices may consist of a plurality of power storage devices which are connected in series.

Another embodiment provides a power supply-side control unit for a power supply system, which comprises a power supply device comprising a plurality of power storage devices connected in parallel, a temperature detection unit operable to detect the temperatures of the power storage devices, and a plurality of switch elements connected in series to the power storage devices respectively; a load electrically connected to the power supply device; and a load-side control unit operable to control the electric power that is consumed or generated by the load, the power supply-side control unit being operable to control the on-state and off-state of the switch elements, wherein the power supply-side control unit performs a temperature control for the plurality of power storage devices by controlling the time ratio between the on-state and off-state of each switch element on the basis of the temperature detected by the temperature detection unit, and wherein the power supply-side control unit transmits a notification signal indicative of the condition of the temperature control to the load-side control unit for controlling the electric power that is consumed or generated by the load.

Meanwhile, in the case where the power supply device further comprises: a voltage detection unit operable to detect the voltage of each of the power storage devices; a current detection unit operable to detect the current of each of the power storage devices; and a remaining charge computation unit operable to compute the remaining amount of charge in each of the power storage devices, the power supply-side control unit transmits the notification signal together with information about the remaining amounts of charge in the power storage devices computed by the remaining charge computation unit, wherein, on the basis of the remaining amounts of charge in the power storage devices and the electric power that is consumed or generated by the load, the load-side control unit computes command values of the time ratios between the on-state and off-state of each switch element for controlling the on-state and off-state thereof, and wherein, in a period in which the temperature control is not performed, the power supply-side control unit controls the switch elements between the on-state and off-state thereof on the basis of the command values received from the load-side control unit.

A further embodiment provides, a load-side control unit for a power supply system, the power supply system comprising: a power supply device comprising a plurality of power storage devices connected in parallel, a temperature detection unit operable to detect the temperatures of the power storage devices, and a plurality of switch elements connected in series to the power storage devices respectively; a load electrically connected to the power supply device; and a power supply-side control unit operable to control the on-state and off-state of the switch elements, the load-side control unit being operable to control the electric power that is consumed or generated by the load, in which the load-side control unit receives a notification signal indicative of the condition of a temperature control performed by the power supply-side control unit for the plurality of power storage devices by controlling the time ratio between the on-state and off-state of each switch element on the basis of the temperature detected by the temperature detection unit, and controls the electric power that is consumed or generated by the load on the basis of the notification signal.

Alternatively, in the case where the power supply device further comprises a voltage detection unit operable to detect the voltage of each of the power storage devices; a current detection unit operable to detect the current of each of the power storage devices; and a remaining charge computation unit operable to compute the remaining amount of charge in each of the power storage devices, the load-side control unit receives a notification signal together with information about the remaining amounts of charge in the power storage devices computed by the remaining charge computation unit, and computes command values of the time ratios between the on-state and off-state of each switch element for controlling the on-state and off-state thereof on the basis of the remaining amounts of charge in the power storage devices and the electric power that is consumed or generated by the load, followed by transmitting the command values to the power supply-side control unit, in order that the power supply-side control unit controls the switch elements between the on-state and off-state thereof on the basis of the command values.

A yet further embodiment provides an electric vehicle comprising: a power supply system having the configuration as recited above; a drive wheel mechanically connected to the load; wherein the load includes an electric motor drive which can generate driving force to be supplied to the drive wheel by electric power which is output from the power supply device, or an electric generator which can convert the rotational power of the drive wheel into electric power to be input to the power supply device.

### BRIEF DESCRIPTION OF THE DRAWINGS

The present embodiments may be better understood, and numerous objects, features, and advantages made apparent to those skilled in the art by referencing the accompanying drawings.

FIG. 1 is a schematic diagram for showing the structure of an electric vehicle 100 according to a first embodiment.

FIG. 2 is a circuit diagram for showing a power supply device 210 according to the first embodiment.

FIG. 3 is a schematic diagram for showing the temperature characteristics of an NTC 40 in accordance with the first embodiment.

FIG. 4 is a circuit diagram for showing a load 220 according to the first embodiment.

FIG. 5 is a flow chart for showing the temperature control performed by a power supply-side control unit 211 according to the first embodiment.

FIG. 6 is a flow chart for showing the process of transmitting a temperature control notification signal from the power supply-side control unit 211 according to the first embodiment.

FIG. 7 is a flow chart for showing the operation of a load-side control unit 221 according to the first embodiment.

FIG. 8 is a circuit diagram for showing a power supply device 210 according to the second embodiment.

FIG. 9 is a sequence diagram showing the operation of a power supply system 200 according to the second embodiment.

### DETAILED DESCRIPTION OF EMBODIMENTS

In what follows, a power supply device according to the embodiment of the present invention will be explained with reference to the accompanying drawings. Meanwhile, the same or similar reference numbers are given to the same or similar components in the accompanying drawings.

However, the drawings are presented only schematically, and the actual configuration should be determined taking into consideration the following description.

### First Embodiment

### Outline of Embodiment

In what follows, a power supply system according to an embodiment will be explained.

The power supply system is provided with a power supply device and a load which is connected to the power supply device.

The power supply device includes a plurality of power storage devices connected to each other in parallel, a plurality of temperature detection units operable to detect the temperatures of the plurality of power storage devices respectively, a plurality of switch elements connected in series to the plurality of power storage devices respectively, and a power supply-side control unit operable to control the on/off state of the switch elements respectively.

The load includes a load-side control unit operable to control the power that is consumed or generated by the load.

The power supply-side control unit performs a temperature control for the plurality of power storage devices respectively by controlling the time ratio between the on-state and off-state of each switch element on the basis of the temperature detected by the temperature detection unit in order to control the on/off state of the switch elements. The power supply-side control unit transmits a temperature control notification signal indicative of the execution condition of the temperature control to the load-side control unit and a maximum input-output electric power value which can be input to or output from the power supply device.

The load-side control unit controls the electric power that is consumed or generated by the load to remain within the range that does not exceed the maximum input-output electric power value which can be input to or output from the power supply device on the basis of the notification transmitted from the power supply-side control unit.

As has been discussed above, in the case of this embodiment, when the maximum input-output electric power value which can be input to or output from the power supply device becomes smaller than a rated input-output electric power value in order to perform the temperature control, the load-side control unit controls the electric power that is consumed or generated by the load such that the electric power does not exceed the maximum input-output electric power value received from the power supply-side control unit. By this configuration, while the life of the power supply device as a whole is prevented from shortening by inhibiting the temperature rise and temperature variation in each power storage device, it is possible to prevent the power supply system from halting due to occurrence of an error.

### (Structure of Electric Vehicle)

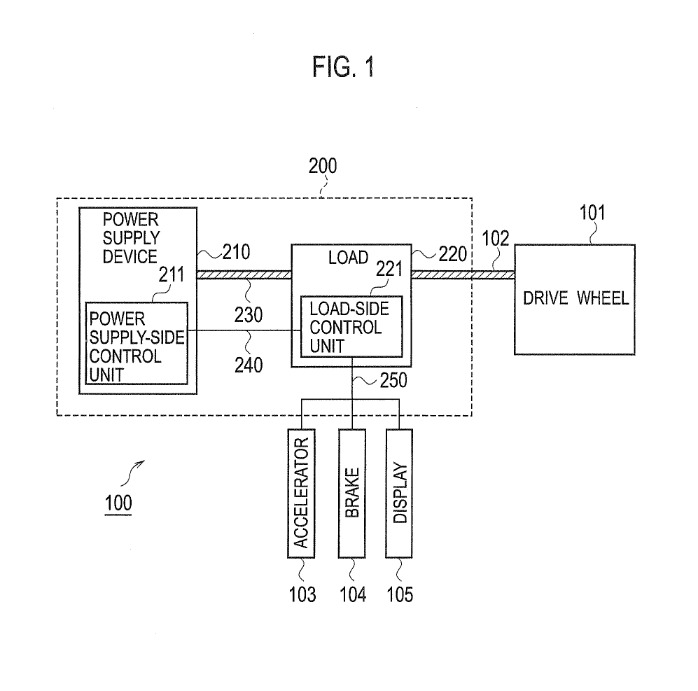

In what follows, an electric vehicle (EV) (or a hybrid electric vehicle (HEV)) according to a first embodiment of the present invention will be explained with reference to the accompanying drawings. FIG. 1 is a schematic diagram for showing the structure of the electric vehicle 100 according to the first embodiment.

As shown in FIG. 1, the electric vehicle 100 is provided with a power supply system 200, drive wheels 101, a power transmission system 102, an accelerator 103, a brake 104 and a display unit 105.

The power supply system 200 includes a power supply device 210 having a power supply-side control unit 211 and a load 220 having a load-side control unit 221. Under the control of the power supply-side control unit 211, the power supply device 210 outputs the electric power that is consumed by the load 220 and receives the electric power that is generated by the load 220. On the other hand, under the control of the load-side control unit 221, the load 220 generates the electric power that is collected in the power supply device 210 (i.e., regenerative electric power), consumes the electric power that is supplied from the power supply device 210, and performs transmission of rotational energy from/to the drive wheels 101. Incidentally, the power supply device 210 and the load 220 are connected through a power cable 230, and the power supply-side control unit 211 and the load-side control unit 221 are connected through a communication cable 240. The structures of the power supply device 210 and load 220 will be described below.

Of the wheels mounted on the electric vehicle 100, the drive wheels 101 are wheels which are mechanically connected to the load 220 through the power transmission system 102. The drive wheels 101 are driven by power supplied from the load 220. Also, when power is not supplied from the load 220, for example when braking the electric vehicle 100, the drive wheel 101 may transmit power to the load 220.

The accelerator 103 is a mechanism to increase or decrease the amounts of power supplied to the drive wheels 101 from the load 220. The brake 104 is a mechanism to brake the drive wheel 101. The display unit 105 serves to display the driving condition of the electric vehicle. In the case of the present embodiment, the display unit 105 displays the controlling condition of the power supply system 200 together with the driving condition of the electric vehicle. The display unit 105 may be for example a meter console, a center console of the electric vehicle 100. The accelerator 103, the brake 104 and the display unit 105 are connected to the load-side control unit 221 through communication cables 250.

### (Structure of Power Supply Device)

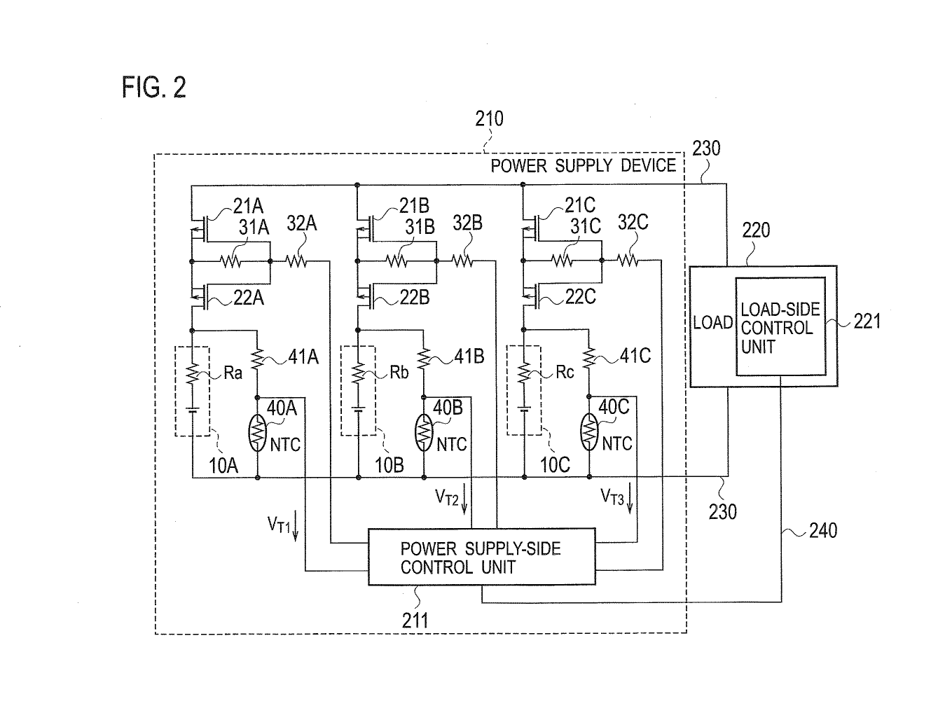

In what follows, the power supply device according to the first embodiment will be explained with reference to the accompanying drawings. FIG. 2 is a circuit diagram for showing the power supply device 210 according to the first embodiment.

As shown in FIG. 2, the electric power supply 210 includes a plurality of power storage devices (power storage devices 10A to 10C), a plurality of switch elements (FETs 21A and 22A to FETs 210 and 22C), a plurality of resistors (resistors 31A and 32A to resistors 31C and 32C), a plurality of temperature detection units (NTC 40A to NTC 400), a plurality of resistors (resistor 41A to resistor 41C), and the power supply-side control unit 211.

The power storage device 10A to the power storage device 100 are connected in parallel to each other through the switch elements respectively, and connected to the load 220 through electric power cables 230. Incidentally, the power storage devices 10A to 100 possess the internal resistances Ra to Rc respectively.

In this case, it should be noted that each of the power storage devices 10A to 10C is provided with and connected to the peripheral circuit having the similar configuration as illustrated. In the following description, therefore, only the peripheral circuit of the power storage device 10A will be described.

The power storage device 10A is a device operable to accumulate electric charge. For example, the power storage device 10A may be a nickel metal-hydride secondary battery, a lithium ion secondary battery, an electric double layer capacitor or the like. The positive electrode of the power storage device 10A is connected to the drain of the FET 22A. The negative electrode of the power storage device 10A is connected to the load 220.

The FETs 21A and 22A are field effect transistors having gate, source and drain electrodes respectively. The FETs 21A and 22A are connected to the power storage device 10A in series, and operable to switch the connection/disconnection state between the power storage device 10A and the load 220.

In the case of the first embodiment, when the FETs 21A and 22A are turned on, the power storage device 10A is connected to the load 220. Conversely, when the FETs 21A and 22A are turned off, the power storage device 10A is disconnected from the load 220.

The source of the FET 21A is connected to one terminal of the resistor 31A and the source of the FET 22A. The drain of the FET 21A is connected to the load 220. The gate of the FET 21A is connected to the other terminal of the resistor 31A and one end of the resistor 32A.

The source of the FET 22A is connected to one terminal of the resistor 31A and the source of the FET 22A. The drain of the FET 22A is connected to the positive electrode of the power storage device 10A. The gate of the FET 22A is connected to the other terminal of the resistor 31A and one end of the resistor 32A. Incidentally, the other terminal of the resistor 32A is connected to the power supply-side control unit 211.

The NTC 40A is a thermistor operable to detect the temperature of the power storage device 10A. In this case, an NTC (Negative Temperature Coefficient) is used as an example of the thermistor. A PTC (Positive Temperature Coefficient) may be also used as an example of the thermistor.

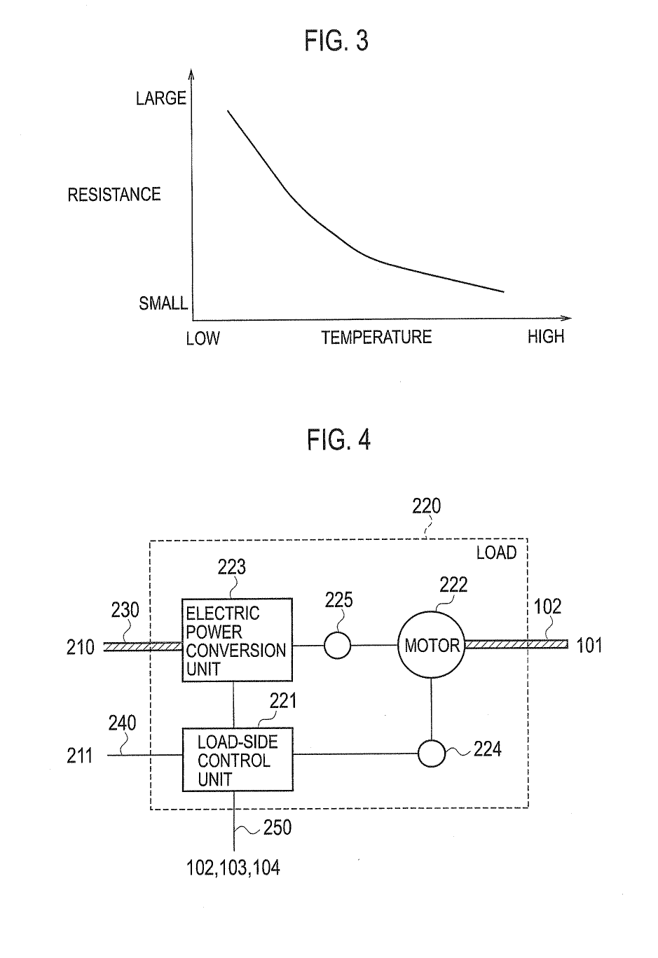

In this case, as illustrated in FIG. 3, the resistance value of the NTC 40A decreases as the temperature of the NTC 40A rises. Also, the NTC 40A is located in the vicinity of the power storage device 10A. The temperature of the NTC 40A is thereby nearly equal to the temperature of the power storage device 10A.

The NTC 40A is connected to the drain of the FET 22A through the resistor 41A in parallel with the power storage device 10A. The resistance value of the NTC 40A can be computed from the voltage VT1 across the NTC 40A, and the temperature of the NTC 40A (i.e., the temperature of the power storage device 10A) can be detected with reference to the resistance value of the NTC 40A.

The power supply-side control unit 211 performs a temperature control by controlling the time ratio between the on-state and the off-state of the switch elements (the FETs 21A and 22A) on the basis of the temperature of the power storage device 10A. More specifically, the power supply-side control unit 211 measures the temperature of the power storage device 10A on the basis of the voltage across the NTC 40A. When the temperature of the power storage device 10A is higher than a predetermined temperature TH, the power supply-side control unit 211 controls the duty ratio of the switch elements connected to the power storage device 10A, i.e., decreases the time ratio of the on-state during controlling the on/off state of the switch elements connected to the power storage device 10A.

The duty ratio is the ratio of the time, in which the power storage device 10A and the load 220 are connected, to a unit time. In other words, the duty ratio is the time ratio of the on-state to the sum of the on-state and the off-state of the switch elements, i.e., the unit time or regular interval.

Preferably, the predetermined temperature TH is lower than the tolerable temperature that is determined in order to safely use the power storage device 10A. For example, in the case where the tolerable temperature of the power storage device 10A is 80° C., the predetermined temperature TH may be set to 70° C.

In this case, the power supply-side control unit 211 transmits a temperature control notification signal indicative of the execution condition of the temperature control to the load-side control unit 221 through the communication cable 240. The temperature control notification signal indicates the maximum input-output electric power value at which the power supply device 210 can input or output power.

Generally speaking, the maximum input-output electric power value may be represented by a maximum power value (W), the ratio of this maximum power value (W) to the rated input-output electric power value (W) of the power supply device, a maximum current value (A), the ratio of this maximum current value (A) to the current value (A) corresponding to the rated input-output electric power value, or the like. In the case of the present embodiment, the maximum input-output electric power value is represented by the ratio (%) of the maximum input-output electric power value to the rated input-output electric power value.

For example, when only the power storage device 10A is temperature controlled to decrease the duty ratio to 70%, the maximum input-output electric power value which can be input to or output from the power supply device 210 is 90% (=(70+100+100)÷3). On the other hand, when none of the power storage devices is temperature controlled, the maximum input-output electric power value is 100%.

### (Structure of Load)

In what follows, the load according to the first embodiment will be explained with reference to the drawings. FIG. 4 is a circuit diagram for showing the load 220 according to the first embodiment.

As shown in FIG. 4, the load 220 is provided with the load-side control unit 221, a motor 222, an electric power conversion unit 223, a rotation sensor 224 and a current sensor 225.

The load-side control unit 221 computes a target torque on the basis of the information obtained from the accelerator 103 and the rotation sensor 224. Also, the load-side control unit 221 computes a target current on the basis of the computed target torque. The load-side control unit 221 controls the electric power conversion unit 223 on the basis of the difference between the computed target current and the current obtained from the current sensor 225.

In this case, when receiving the temperature control notification signal from the power supply-side control unit 211, the load-side control unit 221 determines whether or not the temperature control is in execution on the basis of the maximum input-output electric power value which can be input to or output from the power supply device 210. More specifically speaking, the load-side control unit 221 determines, if the maximum input-output electric power value is 100%, that the temperature control is not in execution, and determines, if the maximum input-output electric power value is lower than 100%, that the temperature control is in execution. The load-side control unit 221 controls the electric power that is consumed or generated by the load 220 in order not to exceed the maximum input-output electric power value. In this case, if the maximum input-output electric power value is lower than 100%, the load-side control unit 221 notifies that the temperature control is in execution, for example, by lighting a lamp in the display unit 105. Furthermore, the load-side control unit 221 indicates the maximum input-output electric power value, for example, by displaying an indicator in the display unit 105.

The motor 222 functions as an electric motor drive which can generate driving force to be supplied to the drive wheels 101 by converting the electric power output from the power supply device 210 into rotational power. Also, when the motor 222 does not consume the electric power output from the power supply device 210 (for example, when the electric vehicle is braked by the brake 104, coasting downhill and so forth), it can serve as an electric generator which converts the rotational power of the drive wheel 101 into electric power (i.e., regenerative electric power) to be input to the power supply device 210. Incidentally, when the load 220 is working as an electric generator, the electric vehicle 100 is braked by a braking force corresponding to the rotational deceleration of the drive wheels 101. Accordingly, as the load 220 generates larger regenerative electric power, the user gets a feeling of larger braking.

The electric power conversion unit 223 converts the electric power which is output from the power supply device 210 into an appropriate form of electric power necessary for use in the motor 222. On the other hand, when the motor 222 regenerates electric power, the electric power conversion unit 223 converts the electric power which is output from the motor 222 into an appropriate form of electric power necessary for storing in the power supply device 210.

The rotation sensor 224 detects the rotational speed of the motor 222. The current sensor 225 detects the amount of current which is supplied to or regenerated by the motor 222.

### (Operation of Power Supply-Side Control Unit)

In what follows, the operation of the power supply-side control unit according to the first embodiment will be explained with reference to the accompanying drawings.

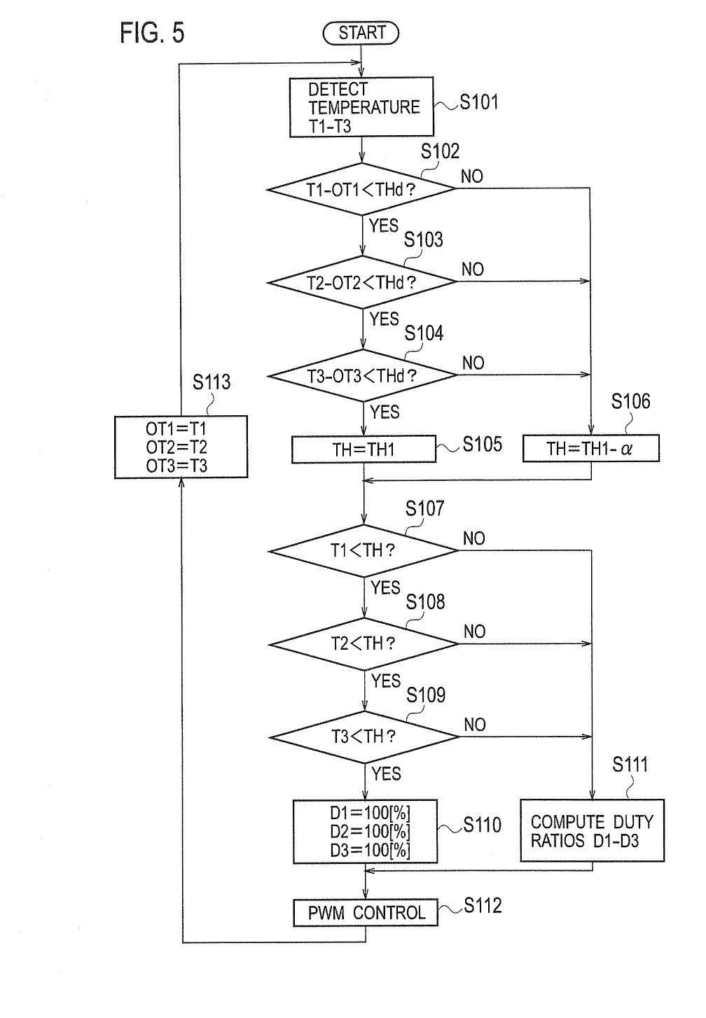

FIG. 5 is a flow chart for showing the temperature control performed by the power supply-side control unit 211 according to the first embodiment.

First, at start up, the temperatures T1 to T3 of the power storage devices 10A to 10C are detected by the NTCs 40A to 40C respectively, and assigned to previous temperatures OT1 to OT3 followed by proceeding to step S101.

In step S101, the power supply-side control unit 211 acquires the values of the temperatures T1 to T3 by detecting these temperatures with the NTCs 40A to 40C again. The differences between the acquired temperatures T1 to T3 and the previous temperatures OT1 to OT3 respectively, and compared with a threshold value THd indicating a predetermined differential temperature in steps S102 to S104. As a result of the comparison, if all the differences are no larger than the threshold value THd, the process proceeds to step S105. Conversely, as a result of the comparison, if any of these differences exceeds the threshold value THd, the process proceeds to step S106.

In step S105 and S106, the power supply-side control unit 211 determines an appropriate temperature TH for starting the temperature control, i.e., current restriction of the power storage devices 10A to 10C on the basis of the differences as described above. In step S105, it is determined that there is no rapid change in temperature, and the process proceeds to step S107 after the temperature TH is set to a predetermined trip temperature TH1. In step S106, it is determined that there is a rapid change in temperature, and the process proceeds to step S107 after the temperature TH is set to the predetermined trip temperature TH1 minus a predetermined temperature α.

In steps S107 to S109, the power supply-side control unit 211 compares the current temperatures T1 to T3 with the temperature TH determined in step S105 or S106. If all the temperatures T1 to T3 are no higher than the temperature TH, the process proceeds to step S110. Conversely, if any of these temperatures T1 to T3 is higher than the temperature TH, the process proceeds to step S111.

In step S110, the power supply-side control unit 211 determines that the temperatures T1 to T3 are sufficiently low, and all the duty ratios D1 to D3 of the switch elements are set to 100% respectively in correspondence with the power storage devices 10A to 10C (i.e., the temperature control or current restriction is not applied) followed by controlling the switch elements on the basis of a PWM control scheme in step S112.

In step S111, the power supply-side control unit 211 determines that the temperatures T1 to T3 become too high, and computes the duty ratios D1 to D3, followed by controlling the switch elements on the basis of the PWM control scheme in accordance with the duty ratios D1 to D3 which are computed in step S112 (i.e., the temperature control or current restriction is applied). Thereafter, the process proceeds to step S113. In step S113, the previous temperatures OT1 to OT3 are updated by assigning the temperatures T1 to T3 thereto, followed by returning to step S101.

Next is a description of an example of the method of computing the duty ratios D1 to D3 in step S111. In this example, the duty ratios D1 to D3 are computed by comparing the temperatures T1 to T3, determining the lowest temperature TS thereamong, computing the ratio of the temperature TS to each of the temperatures T1 to T3 as each of the duty ratios D1 to D3. That is, the duty ratios D1 to D3 are computed as D1=TS/T1, D2=TS/T2 and D3=TS/T3. As a result, while the duty ratio of the power storage device having the lowest temperature is computed as 100%, the duty ratios of the other power storage devices are computed as values lower than 100% respectively.

More specifically speaking, when the temperatures T1, T2 and T3 are 60° C., 70° C. and 80° C. respectively, the duty ratio D1 is computed as 60/60×100=100%; the duty ratio D2 as 60/70×100≈86%; and the duty ratio D3 as 60/80×100=75%.

Incidentally, in step S111, the duty ratios D1 to D3 are computed on the basis of variation of the temperatures T1 to T3. However, the duty ratios D1 to D3 can be computed separately for the power storage devices respectively.

As apparent from the above description, the interval between measurement of the temperatures T1 to T3 and measurement of the previous temperatures OT1 to OT3 is equal to one cycle time of the process stored in the flow chart of FIG. 5. However, a pause of a predetermined length may be optionally inserted between assignment of the temperatures T1 to T3 to the previous temperatures OT1 to OT3 and subsequent measurement of the temperatures T1 to T3 for updating. Namely, when the process is returned from step S112 to step S101 in the flow chart of FIG. 5, a step may be provided for inserting a pause between these steps. The predetermined length can be determined depending on the temperature change tendency of the power storage device 10, the power supply device 210 and so forth. In the case where the temperature does not change so widely, the predetermined length is set to a larger value.

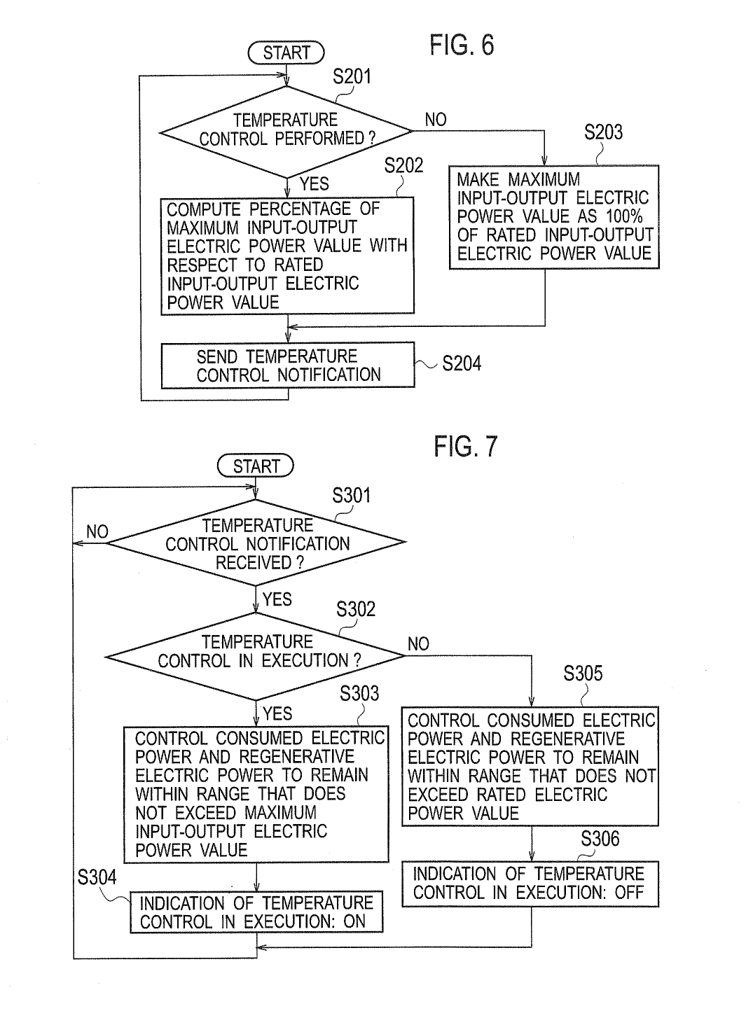

FIG. 6 is a flow chart for showing the process of transmitting a temperature control notification signal from the power supply-side control unit 211 according to the first embodiment.

First, in step S201, the power supply-side control unit 211 determines whether or not the temperature control is in execution. If the temperature control is in execution, the process proceeds to step S202. If the temperature control is not in execution, the process proceeds to step S203.

In step S202, the power supply-side control unit 211 computes the maximum input-output electric power value, which can be input to or output from the power supply device 210, as a percentage (%) of the rated input-output electric power value on the basis of the duty ratios D1 to D3 as discussed above. For example, when D1=100%, D≈86% and D3=75%, the maximum input-output electric power value in relation to the rated input-output electric power value are computed as (100+86+75)/3=87(%).

In step S203, the power supply-side control unit 211 assigns 100% to the maximum input-output electric power value, which can be input to or output from the power supply device 210, in relation to the rated input-output electric power value.

In step S204, the power supply-side control unit 211 transmits a temperature control notification signal indicative of the execution condition of the temperature control to the load-side control unit 221, and the maximum input-output electric power value which can be input to or output from the power supply device 210, i.e., a percentage (%) of the rated input-output electric power value in the case of the first embodiment. The process is then returned to step S201.

Incidentally, the power supply-side control unit 211 periodically performs the process in steps S201 to S204.

### (Operation of Load-Side Control Unit)

In what follows, the operation of the load-side control unit according to the first embodiment will be explained with reference to the accompanying drawings. FIG. 7 is a flow chart for showing the operation of the load-side control unit 221 according to the first embodiment.

In step S301, the load-side control unit 221 determines whether or not the temperature control notification signal is received from the power supply-side control unit 211. If the temperature control notification signal is received, the process proceeds to step S302. Conversely, while the temperature control notification signal is not received, the process in step S301 is repeated.

In step S302, the load-side control unit 221 determines whether or not the temperature control is in execution with reference to the temperature control notification signal. More specifically speaking, the load-side control unit 221 determines that the temperature control is not in execution if the maximum input-output electric power value is 100%, and that the temperature control is in execution if the maximum input-output electric power value is lower than 100%. If the temperature control is in execution, the process proceeds to step S303. If the temperature control is not in execution, the process proceeds to step S305.

In step S303, the load-side control unit 221 controls the electric power that is consumed by the load 220 or the regenerative electric power that is generated by the load 220 with reference to the maximum input-output electric power value indicated by the temperature control notification signal such that the consumed or regenerative electric power does not exceed the maximum input-output electric power value. By this configuration, the electric power exchanged between the power supply device 210 and the load 220 is controlled by the load-side control unit 221 in order not to exceed the maximum input-output electric power value.

In step S304, the load-side control unit 221 activates the indication indicating that the temperature control is in execution. Specifically speaking, for example, the load-side control unit 221 turns on the lamp in the display unit 105 to indicates that the temperature control is in execution. Also, the load-side control unit 221 displays the maximum input-output electric power value in the display unit 105.

On the other hand, in step S305, the load-side control unit 221 controls power transmission in accordance with the rated input-output electric power value as the maximum input-output electric power value, which can be input to or output from the power supply device 210. Namely, the load-side control unit 221 controls the electric power that is consumed by the load 220 or the regenerative electric power that is generated by the load 220 in order not to exceed the rated input-output electric power value.

In step S306, the load-side control unit 221 deactivates the indication indicating that the temperature control is in execution. Specifically speaking, for example, the load-side control unit 221 turns off the lamp in the display unit 105 to indicates that the temperature control is not in execution. Also, the load-side control unit 221 displays the rated input-output electric power value as the maximum input-output electric power value in the display unit 105.

Next is a description of two examples of the method of controlling the power consumption of the load 220 in step S303. In this description, an maximum output power value is used as the maximum input-output electric power value, and a rated output power value is used as the rated input-output electric power value.

The first example is such that the power consumption control is performed on the basis of the temperature control notification signal only when the accelerator 103 is operated in order to make the power consumption of the load 220 exceed the maximum output power value. In this case, the power consumption is not increased but fixed (controlled) to the maximum output power value when such operation is made by excessively pressing down on the accelerator, or excessively rotating an accelerator grip (in the case of a motorcycle or the like). Accordingly, the user can get the intended acceleration of the electric vehicle 100 as long as the power consumption of the load 220 does not exceed the maximum output power value.

The second example is such that the power consumption of the load 220 is uniformly decreased (reduced) throughout all the operational range of the accelerator 103 by the ratio of the maximum output power value to the rated output power value in comparison with the power consumption expected when the temperature control is not in execution. Accordingly, while the user can accelerate the electric vehicle 100 throughout all the operational range of the accelerator 103, the acceleration is uniformly reduced by the ratio of the maximum output power value to the rated output power value.

Incidentally, when the ratio of the maximum output power value to the rated output power value is 100%, the power consumption is fixed to the rated output power value only when the accelerator 103 is operated in order to make the power consumption of the load 220 exceed the rated output power value.

Next is a description of two examples of the method of controlling the regenerative electric power of the load 220 in step S303. In this description, an maximum input power value is used as the maximum input-output electric power value, and a rated input power value is used as the rated input-output electric power value.

The first example is such that the regenerative electric power is fixed (controlled) to the maximum input power value only when the regenerative electric power can exceed the maximum input power value. Accordingly, if the regenerative electric power does not exceed the maximum input power value, the regeneration is not controlled. For example, in the case where each of the power storage devices 10A to 10C has a rated input voltage of 36[V], a capacity of 2 [Ah] and a maximum input current of 0.5 [C] (1 [A]), the rated input power value of the power supply device 210 is computed as 3×36 [V]×1 [A]=108 [W]. Accordingly, if the ratio of this maximum input power value to the rated input power value is 87%, the regenerative electric power is restricted to 86. 4(=108 [W]×0.8) [W] when the regenerative electric power exceeds the maximum input power value.

The second example is such that the regenerative electric power of the load 220 is uniformly decreased (reduced) by the ratio of the maximum input power value to the rated input power value in comparison with the regenerative electric power expected when the temperature control is not in execution. Accordingly, even when the regenerative electric power does not exceed the maximum input power value, the regenerative electric power is restricted by the ratio of the maximum input power value to the rated input power value.

Incidentally, if the ratio of the maximum input power value to the rated input power value is 100%, the regenerative electric power is fixed to the rated input power value only when the regenerative electric power of the load 220 can exceed the maximum input power value.

### (Operation and Effects)

In the case of the first embodiment, when any of the temperatures detected by the NTC 40A to the NTC 40C is higher than the predetermined temperature TB, the power supply-side control unit 211 performs the duty ratio control by controlling the duty ratios of the FETs 21A and 22A to the FETs 21C and 22C, i.e., decreasing the time ratio of the on-state during controlling the on/off state of each switch element.

Accordingly, it is possible to inhibit the temperatures of the power storage devices 10A to 100 from rising beyond the predetermined temperature TH respectively. Because of this, it is possible to inhibit the variation in temperature among the power storage devices 10A to 100.

As a result, it is possible to inhibit the variation in degradation among the power storage devices 10A to 100, and thereby improve the life of the power supply device 210.

Also, the power supply-side control unit 211 transmits a temperature control notification signal indicative of the execution condition of the temperature control to the load-side control unit 221, which in turn controls the electric power that is consumed or generated by the load 220 on the basis of the temperature control notification signal. More specifically speaking, the electric power that is consumed or generated by the load 220 is controlled in order not to exceed the maximum input-output electric power value which can be input to or output from the power supply device 210.

Accordingly, it is possible to inhibit the power supply system 100 from being halted by error due to electric power exceeding the maximum input-output electric power value input to or output from the power supply device 210.

Also, the load-side control unit 221 notifies the user of the execution condition of the temperature control. Accordingly, the user can recognize in advance that the rotational speed of the motor 222 may not correspond the operation amount of the accelerator 103, i.e., that, even when operating the accelerator 103, the vehicle may gain less acceleration than expected. Also, the user can recognize in advance that a feeling of braking is lessened because of reduction in generating the regenerative electric power from the load 220. As a result, it is possible to lessen the stress of the user that electric power cannot be input to or output from the power supply device 210 at 100% of the rated input-output electric power value.

### Second Embodiment

In what follows, a power supply system according to a second embodiment will be explained. The second embodiment will be explained mainly with respect to the differences from the first embodiment.

Specifically speaking, in the case of the second embodiment, the on-state and off-state of each switch element are controlled on the basis of a command value generated by the load-side control unit 221 in a period in which the temperature control is not performed by the power supply-side control unit for the purpose of correcting the variation in the remaining amounts of charge in the power storage devices 10A to 100. The load-side control unit 221 computes the command value in accordance with the remaining amounts of charge in the power storage devices 10A to 100.

### (Structure of Power Supply Device)

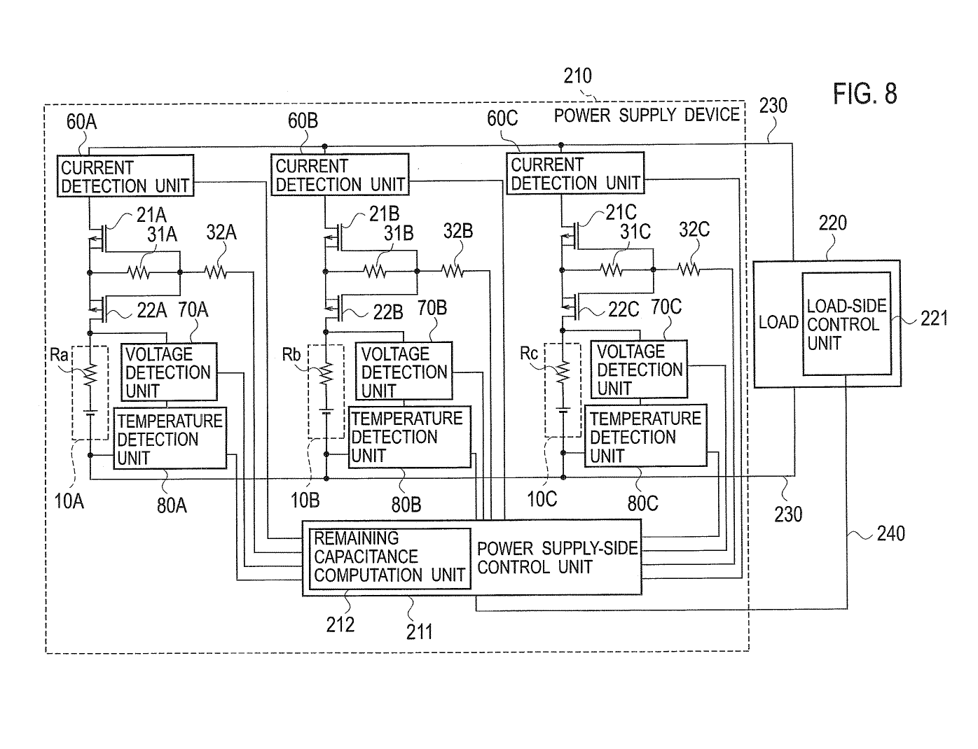

In what follows, the power supply device according to the second embodiment will be explained with reference to the accompanying drawings. FIG. 8 is a circuit diagram for showing the power supply device 210 according to the second embodiment.

As shown in FIG. 8, the electric power supply 210 according to the second embodiment includes a plurality of current detection units (current detection units 60A to 600), a plurality of voltage detection units (voltage detection units 70A to 700), a plurality of temperature detection units (temperature detection units 80A to 800), and a remaining charge computation unit 212.

The current detection unit 60A to 60C are connected in series with the power storage devices 10A to 100 respectively in order to detect the amounts of current through the power storage devices 10A to 100.

The voltage detection units 70A to 70C are provided connected in parallel with the power storage devices 10A to 100 respectively, and serve to detect the voltages across the power storage devices 10A to 100 respectively.

The temperature detection units 80A to 80C are provided connected in parallel with the power storage devices 10A to 100 respectively, and serve to detect the temperatures of the power storage devices 10A to 100 respectively.

The remaining charge computation unit 212 is provided in the power supply-side control unit 211, and computes the remaining amounts of charge in the power storage devices 10A to 100 on the basis of at least one of the current value, voltage value and temperature of each of the power storage devices 10A to 100 detected by the current detection unit 60A to 60C, the voltage detection units 70A to 70C and the temperature detection units 80A to 80C respectively.

Incidentally, when the temperature of the power storage device 10A, 10B or 100 as detected by the temperature detection unit 80A, 80B or 800 reaches a predetermined temperature TH, the power supply-side control unit 211 controls the duty ratio of the switch elements connected to the power storage device 10A, 10B or 100, i.e., decreases the time ratio of the on-state during controlling the on/off state of the switch elements connected to the power storage device 10A, 10B or 100 in the same manner as in the first embodiment.

The temperature control notification signal output from the power supply-side control unit 211 contains the information about the remaining amounts of charge in the power storage devices 10A to 100.

Also, the power supply-side control unit 211 controls the on-state and off-state of each switch element in a period in which the temperature control is not performed on the basis of the command values corresponding to the duty ratios D11 to D31. The command values of the duty ratios D11 to D31 can be computed by the load-side control unit 221 on the basis of the remaining amounts of charge in the power storage devices 10A to 10C and the electric power that is consumed or generated by the load 220.

### (Operation of Power Supply System)

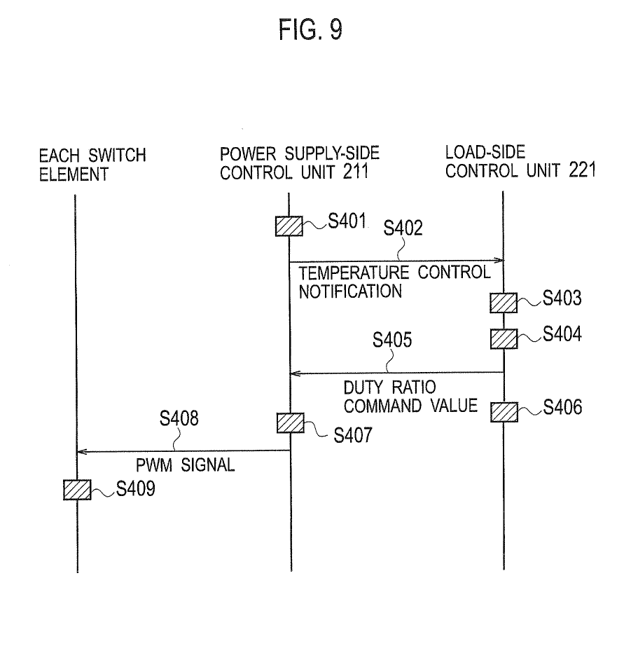

In what follows, the operation of the power supply system according to the second embodiment will be explained with reference to the accompanying drawings. FIG. 9 is a sequence diagram showing the operation of the power supply system 200 according to the second embodiment.

Meanwhile, in the following description, it is assumed that the power supply-side control unit 211 and the load-side control unit 221 perform the same control processes as in the first embodiment.

In step S401, the power supply-side control unit 211 computes the remaining amounts of charge in the power storage devices 10A to 100 on the basis of at least one of the current value, voltage value and temperature of each of the power storage devices 10A to 100 detected by the current detection units 60A to 60C, the voltage detection units 70A to 70C and the temperature detection units 80A to 80C respectively.

In step S402, the power supply-side control unit 211 transmits the computed temperature control notification signal including the remaining amounts of charge in the power storage devices 10A to 100 to the load-side control unit 221.

In step S403, on the basis of the remaining amounts of charge in the power storage devices 10A to 100 and the electric power that is consumed or generated by the load 220, the load-side control unit 221 computes command values of the time ratios (hereinafter referred to as “the duty ratios D11 to D31”) between the on-state and off-state of each switch element for controlling the on-state and off-state thereof. More specifically, when the user is operating the accelerator 103, i.e., when the load 220 is consuming electric power, the load-side control unit 221 computes the duty ratios D11 to D31 in proportion to the remaining amounts of charge in the power storage devices 10A to 100 respectively. For example, if the remaining amounts of charge in the power storage devices 10A to 100 are 80%, 70% and 60% respectively, the duty ratios D11 to D31 are computed as D1=80/80=100%, D2=70/80=87. 5%, D3=60/80=75% under the condition that the duty ratio of the power storage device which is most charged is set to 100%. On the other hand, when the user is operating the brake 104 or coasting downhill, i.e., regenerative electric power is generated by the load 220, the load-side control unit 221 computes the duty ratios D11 to D31 in inverse proportion to the remaining amounts of charge in the power storage devices 10A to 100 respectively. For example, if the remaining amounts of charge in the power storage devices 10A to 100 are 80%, 70% and 60% respectively, the duty ratios D11 to D31 are computed as D1=60/80=75%, D2=60/70=85. 7%, D3=60/60=100% under the condition that the duty ratio of the power storage device which is least charged is set to 100%. Incidentally, if the remaining amounts of charge in the power storage devices 10A to 100 are equal to each other, the duty ratios D11 to D31 are computed as 100% respectively.

In step S404, the load-side control unit 221 determines whether or not the electric power that is consumed or generated by the load 220 is greater than the maximum input-output electric power value which can be input to or output from the power supply device 210 on the basis of the duty ratios D11 to D31. Specifically speaking, in the case where the rated output electric power value of the power supply device 210 is 3600 W, for example, when D1=100%, D2=87.5% and D3=75% while the load 220 is consuming electric power, the maximum output power value is computed as 3150 W (=(3600×(100+87.5+75)/3)/100) . Accordingly, the load-side control unit 221 determines whether or not the electric power that, is consumed by the load 220 is greater than 3150 W. Likewise, when the load 220 is generating electric power, i.e., regenerating electric power, the load-side control unit 221 determines whether or not the electric power that is generated by the load 220 is greater than the maximum input power value. When the electric power that is consumed or generated by the load 220 is not greater than the maximum input-output electric power value, it is determined that the power supply-side control unit 211 can control electric power on the basis of the duty ratios D11 to D31, followed by proceeding to step S405. On the other hand, when the electric power that is consumed or generated by the load 220 is greater than the maximum input-output electric power value, the duty ratios D11 to D31 are reset to 100%, followed by proceeding to step S405.

In step S405, the load-side control unit 221 transmits command values of the duty ratios D11 to D31 to the power supply-side control unit 211.

In step S406, the load-side control unit 221 indicates the maximum input-output electric power value which can be input to or output from the power supply device 210 on the basis of the duty ratios D11 to D31, for example, by displaying an indicator in the display unit 105.

In step S407, in a period in which the temperature control is not performed, the power supply-side control unit 211 generates PWM signals corresponding to the duty ratios D11 to D31 with reference to the command values received from the load-side control unit 221, and outputs them to the switch elements respectively. Meanwhile, in a period in which the temperature control is performed, it should be noted that the power supply-side control unit 211 generates PWM signals corresponding to the duty ratios D11 to D31 on the basis of the temperature control which is described in accordance with the first embodiment.

In step S408, the power supply-side control unit 211 outputs the PWM signals to the switch elements respectively.

In step S409, each switch element switches between the on-state and off-state thereof in accordance with the PWM signal.

### (Operation and Effects)

In the case of the second embodiment, the power supply-side control unit 211 outputs the temperature control notification signal including the information about the remaining amounts of charge in the power storage devices 10A to 10C. The load-side control unit 221 computes the command values of the duty ratios D11 to D31 on the basis of the remaining amounts of charge in the power storage devices 10A to 10C and the electric power that is consumed or generated by the load 220, and transmits the computed command values to the power supply-side control unit 211. In a period in which the temperature control is not performed, the power supply-side control unit 211 controls the switch elements between the on-state and off-state thereof on the basis of the command value of the duty ratios D11 to D31.

Accordingly, in a period in which the temperature control is not performed, the power supply-side control unit 211 can correct the variation in the remaining amounts of charge in the power storage devices 10A to 10C caused due to execution of the temperature control.

Also, the load-side control unit 221 operates with reference to the electric power that is consumed or generated by the load 220. Specifically speaking, when the electric power that is consumed or generated by the load 220 is greater than the maximum input-output electric power value which can be input to or output from the power supply device 210 on the basis of the duty ratios D11 to D31, the duty ratios D11 to D31 are set to 100% respectively, i.e., the correction process for correcting the variation in the remaining amounts of charge in the power storage devices 10A to 10C is not performed.

Accordingly, in a period in which the temperature control process is not performed, it can be avoided to have such a situation that the electric power that is consumed or generated by the load 220 cannot be input or output, and have the power supply system 200 stopped by error.

### Other Embodiments

While the present invention has been described in conjunction with the above embodiments, the present invention should not be limited to the description and drawings as part of the disclosure. The various alternative embodiments, practical applications and implementations will be apparent to those skilled in the art from the disclosure.

In accordance with the embodiments as has been discussed above, when the temperature of the power storage device 10A, 10B or 100 reaches a predetermined temperature TH, the power supply-side control unit 211 controls the duty ratio of the switch elements, i.e., decreases the time ratio of the on-state during controlling the on/off state of the switch elements. However, the present invention is not limited thereto. For example, when the temperature of the power storage device 10A, 10B or 100 reaches a predetermined temperature TH, the power supply-side control unit 211 may turn off the switch elements.

In the case of the embodiments as has been discussed above, the power supply-side control unit 211 collectively controls the power storage devices 10A, 10B and 100. However, the present invention is not limited thereto. For example, there may be a plurality of units, each serving as the power supply-side control unit 211, separately provided for the power storage devices 10A to 100 respectively. Also, while the power supply system 200 is provided with only one load-side control unit 221, the load-side control unit 221 may be separately provided for each of the power storage devices 10A to 100. In this case, for each of the power storage devices 10A to 100, while the corresponding power supply-side control unit transmits a temperature control notification signal indicative of the execution condition of the temperature control to the corresponding load-side control unit, which in turn transmits a command value of the time ratio between the on-state and off-state of each switch element for controlling the on-state and off-state thereof to the corresponding power supply-side control unit.

In accordance with the embodiments as has been discussed above, the power supply-side control unit 211 collectively controls the temperatures T1 to T3 of the power storage devices 10A to 100 on the basis of the variation among the temperatures T1 to T3 of the power storage devices 10A to 100. However, the power supply-side control unit 211 can be designed to separately control the temperatures T1 to T3 of the power storage devices 10A to 100 on the basis of the temperatures T1 to T3 respectively.

In accordance with the embodiments as has been discussed above, while the power supply device 210 is provided with the power supply-side control unit 211, the load 220 is provided with the load-side control unit 221. However, the power supply-side control unit 211 and the load-side control unit 221 may be provided in other locations as long as they are located in the power supply system 200.

In accordance with the second embodiment as has been discussed above, the remaining charge computation unit 212 provided in the power supply-side control unit 211 collectively computes the remaining amounts of charge in the power storage devices 10A to 100. However, the present invention is not limited thereto. For example, the remaining charge computation unit 212 may be separately provided for each of the power storage devices 10A to 100.

In accordance with the embodiments as has been discussed above, the temperature control notification signal includes the maximum input-output electric power value. The temperature control notification signal may includes data indicative of whether or not the temperature control is in execution. For example, the temperature control notification signal may includes a flag indicative of whether or not the temperature control is in execution (for example, when the temperature control is in execution, the flag is set to ON).

In accordance with the second embodiment as has been discussed above, the load-side control unit 221 computes the command values of the duty ratios D11 to D31 for use in correction of the variation in the remaining amounts of charge in the power storage devices, and transmits the duty ratios D11 to D31 to the power supply-side control unit 211. However, the power supply-side control unit 211 may instead compute the command values of the duty ratios D11 to D31. In this case, when the power supply-side control unit 211 controls the switch elements on the basis of the duty ratios D11 to D31, it is preferred to notify the load-side control unit 221 of the execution condition of the control process. The load-side control unit 221 can control the electric power that is consumed or generated by the load 220 to remain within the range that does not exceed the maximum input-output electric power value of the power supply device 210 on the basis of the duty ratios D11 to 031. By this configuration, in a period in which the temperature control is not performed, it is possible to inhibit the power supply system 200 from being halted by error during performing the control process on the basis of the duty ratios D11 to 031.

In accordance with the embodiments as has been discussed above, the temperature detection unit is implemented with a thermistor. However, needless to say, the temperature detection unit is not limited thereto.

In accordance with the embodiments as has been discussed above, the switch element is implemented with an FET. However, needless to say, the switch element is not limited thereto. For example, the switch element may be implemented with a bipolar transistor.

Although not specifically stated in the above embodiments, each power storage device 10 may consist of a plurality of power storage devices which are connected in series. In this case, it is possible to make the power supply device 210 high power.

Although not specifically stated in the above embodiments, the power supply-side control unit 211 may transmit, in advance of performing the temperature control, the maximum input-output electric power value, which can be input to or output from the power supply device 210 and computed on the basis of the duty ratios for use in the temperature control, to the load-side control unit 221, and the load-side control unit 221 may control the electric power that is consumed or generated by the load 220 on the basis of the maximum input-output electric power value received from the power supply-side control unit 211. In this case, the temperature rise of the power storage devices 10A to 100 can be inhibited, and thereby it is avoided that the temperature control is frequently performed by the power supply-side control unit 211.

In accordance with the embodiments as has been discussed above, the circuit configuration of the power supply device 210 is described for illustrative purposes. However, it is possible to modify the circuit configuration of the power supply device 210.

In accordance with the embodiments as has been discussed above, the power supply system 200 is used in the electric vehicle 100. However, the power supply system 200 can be used for a variety of electric devices including information equipment.

Finally, the embodiments of the present invention can be modified without departing from the scope of the technical concept as recited in the claims.

In accordance with the present invention, it is possible to provide a power supply system and a power supply-side control unit and an electric vehicle wherein, while the life of the power supply device as a whole is prevented from shortening by inhibiting the temperature rise of each power storage device and the variation in temperature among the power storage devices, the power supply system is prevented from halting due to occurrence of an error.

The present invention may be embodied in other specific forms without departing from the spirit or essential characteristics thereof. The embodiments are therefore to be considered in all respects as illustrative and not restrictive, the scope of the present invention being indicated by the appended claims rather than by the foregoing description, and all changes that come within the meaning and range of equivalency of the claims therefore are intended to be embraced therein.

What is claimed is:

1. A power supply system, comprising:
a power supply device comprising a plurality of power storage devices connected in parallel, a plurality of temperature detection units operable to detect respective temperatures of the power storage devices, and a plurality of switch elements respectively connected in series to the plurality of power storage devices;
a load electrically connected to the power supply device;
a power supply-side control unit operable to control the on-state and off-state of the switch elements;
a load-side control unit operable to control the electric power that is consumed or generated by the load,
wherein the power supply-side control unit performs a temperature control for the plurality of power storage devices by controlling a time ratio of the on-state and off-state of each switch element based on the temperatures detected by the plurality of temperature detection units,
wherein the power supply-side control unit transmits a notification signal indicative of the execution condition of the temperature control to the load-side control unit, and
wherein the load-side control unit controls the electric power that is consumed or generated by the load based on the notification signal received from the power supply-side control unit.

2. The power supply system of claim 1,
wherein the notification signal contains information about the maximum input-output electric power value which can be input to or output from the power supply device, and
wherein the load-side control unit controls the electric power that is consumed or generated by the load to remain within the range that does not exceed the maximum input-output electric power value.

3. The power supply system of claim 1, wherein the load-side control unit notifies a user of an execution condition of the temperature control through the notification signal.

4. The power supply system of claim 1, wherein the power supply device comprises:
a plurality of voltage detection units operable to detect respective voltages of the plurality of power storage devices;
a plurality of current detection units operable to detect respective currents of the plurality of power storage devices; and
a remaining charge computation unit operable to compute the remaining amount of charge in each of the power storage devices,
wherein the power supply-side control unit transmits the notification signal together with information about the remaining amounts of charge in the power storage devices computed by the remaining charge computation unit,
wherein, based on the remaining amounts of charge in the power storage devices and the electric power that is consumed or generated by the load, the load-side control unit computes command values of the time ratios of the on-state and off-state of the switch elements for controlling the on-state and off-state thereof, and transmits the command values to the power supply-side control unit and
wherein, in a period in which the temperature control is not performed, the power supply-side control unit controls the on-state and off-state of the switch elements based on the command values received from the load-side control unit.

5. A power supply-side control unit operable to control the on-state and off-state of switch elements in a power supply system that comprises a power supply device comprising a plurality of power storage devices connected in parallel, a plurality of temperature detection units operable to detect temperatures of the power storage devices, and a plurality of switch elements respectively connected in series to the power storage devices; a load electrically connected to the power supply device; and a load-side control unit operable to control the electric power that is consumed or generated by the load,
wherein the power supply-side control unit performs a temperature control for the plurality of power storage devices by controlling a time ratio of the on-state and off-state of the switch elements based on temperatures detected by the temperature detection units, and
wherein the power supply-side control unit transmits a notification signal indicative of the condition of the temperature control to the load-side control unit for controlling the electric power that is consumed or generated by the load.

6. An electric vehicle, comprising:
a power supply system of claim 1; and
a drive wheel mechanically connected to the load,
wherein the load includes an electric motor which generates driving force to be supplied to the drive wheel by electric power which is output from the power supply device, or an electric generator which converts rotational power of the drive wheel to electric power to be input to the power supply device.
